(19) United States
(12) Patent Application Publication
(10) Pub. No.: US 2018/0187673 A1
(43) Pub. Date: Jul. 5, 2018

(54) SELF-RECIPROCATING HYDRAULIC LINEAR ACTUATOR

(71) Applicant: General Electric Company, Schenectady, NY (US)

(72) Inventors: Deepak Trivedi, Halfmoon, NY (US); Christopher Edward Wolfe, Niskayuna, NY (US); Brian Paul Reeves, Edmond, OK (US); Bodhayan Dev, Niskayuna, NY (US)

(21) Appl. No.: 15/397,514

(22) Filed: Jan. 3, 2017

(51) Int. Cl. F04B 47/08; F15B 15/14; F15B 15/22; F15B 1/02; F15B 11/10; E21B 43/12

(52) U.S. Cl. CPC F04B 47/08; F15B 15/1447; F15B 15/1428; F15B 15/22; F15B 1/02; F04B 2203/0903; E21B 43/121; F15B 2211/212; F15B 2211/205; F15B 2211/755; F15B 11/10

(57) ABSTRACT

An actuator for use with a fluid transfer device is provided. The actuator includes a piston cylinder having a longitudinal axis and defining a piston chamber having both a head end and a longitudinally opposite base end. The actuator further includes a piston disposed within the piston chamber. The piston movable between a first piston position proximate the piston chamber head end and a second piston position proximate the piston chamber base end. The piston includes a piston head end having a first indexing mechanism, a first piston seal, and at least one first feed hole. The piston further includes a base end longitudinally opposite the head end having a second indexing mechanism, a guide tooth, a second piston seal, and at least one second feed hole. The piston defines a plurality of channels that extends from proximate the first piston seal to proximate the second piston seal.

### BACKGROUND

The field of the disclosure relates generally to oil and gas downhole pump assemblies and, more specifically, to actuators for use in downhole pump assemblies.

At least some known rod pumps are used in oil and gas wells, for example, to pump fluids from subterranean depths towards the surface. In operation, a pump assembly is placed within a well casing, well fluid enters the casing through perforations, and mechanical lift forces the fluids from the subterranean depths towards the surface. For example, at least some known rod pumps utilize a downhole pump with complicated geometries, which by reciprocating action of a rod string, lifts the well fluid towards the surface.

Oil and gas well pump systems feature reciprocating pumps that go underground to pump fluid from a well. This is traditionally accomplished by way of a motor that operates hydraulic pistons, which utilize reciprocating motion to pump fluid to the surface. A complex system of hydraulic circuits, valves, cables and electronic controls are often required to create the reciprocating motion of the piston. The utilization of switching valves and controls to cause the piston to reciprocate in traditional hydraulic circuits require additional components such as electronics, control systems, and cables connecting to those controls. This is often challenging and costly due to the space required for the components and the harsh conditions encountered beneath the surface, where the required length of the cables can be as long as 10,000 meters (m) (32,808 feet (ft)). The complexities of the systems combined with harsh conditions encountered during operation may result in a decrease of the reliability of the system and its components, which may lead to increased maintenance costs and down time over the service life of the pump system.

### BRIEF DESCRIPTION

In one aspect, an actuator for use with a fluid transfer device is provided. The actuator includes a piston cylinder having a longitudinal axis and defining a piston chamber having both a piston chamber head end and a longitudinally opposite piston chamber base end. The actuator further includes a piston disposed within the piston chamber. The piston movable between a first piston position proximate the piston chamber head end and a second piston position proximate the piston chamber base end. The piston includes a piston head end having a first indexing mechanism, a first piston seal, and at least one first feed hole. The piston further includes a base end longitudinally opposite the head end. The piston base end includes a second indexing mechanism, a guide tooth, a second piston seal, and at least one second feed hole. The piston defines a plurality of channels. The plurality of channels extend from proximate the first piston seal to proximate the second piston seal.

In another aspect, a fluid transfer system is provided. The fluid transfer system includes, a motor, a fluid transfer device coupled to the motor, and an actuator. The actuator includes a piston cylinder having a longitudinal axis and defining a piston chamber having both a piston chamber head end and a piston chamber base end. The piston chamber base end is longitudinally opposite the piston chamber head end. The actuator further includes a piston disposed within the piston chamber. The piston is movable between a first piston position proximate the piston chamber head end and a second piston position proximate the piston chamber base end. The piston includes a piston head end having both a first indexing mechanism and a first piston seal. The piston head end having at least one first feed hole. The piston further includes a piston base end longitudinally opposite the piston head end. The piston base end includes a second indexing mechanism, a guide tooth, and a second piston seal. The piston base end having at least one second feed hole. The piston defines a plurality of channels. The plurality of channels extend from proximate the first piston seal to proximate the second piston seal.

In yet another aspect, a resource recovery system is provided. The resource recovery system includes, a wellhead, a production location coupled to the wellhead and configured to receive resources from the wellhead, and a fluid transfer system. The fluid transfer system includes a motor, a fluid transfer device coupled to the motor, and an actuator. The actuator includes a piston cylinder having a longitudinal axis and defining a piston chamber having both a piston chamber head end and a piston chamber base end. The piston chamber base end is longitudinally opposite the piston chamber head end. The actuator further includes a piston disposed within the piston chamber. The piston movable between a first piston position proximate the piston chamber head end and a second piston position proximate the piston chamber base end. The piston includes a piston head end having a first indexing mechanism and a first piston seal. The piston head end having at least one first feed hole. The piston further includes a piston base end longitudinally opposite the piston head end. The piston base end includes a second indexing mechanism, a guide tooth, and a second piston seal. The piston base end having at least one second feed hole. The piston defines a plurality of channels. The plurality of channels extend from proximate the first piston seal to proximate the second piston seal.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic side view of an exemplary resource recovery system having an exemplary fluid transfer system;

FIG. 2 is a schematic perspective view of the exemplary actuator shown in FIG. 1;

FIG. 3 is a schematic perspective view of an exemplary head end of the piston shown in FIG. 2;

FIG. 4 is a schematic perspective view of an exemplary base end of the piston shown in FIG. 2;

FIG. 5 is a schematic cross-sectional view of the actuator shown in FIG. 2, taken along Line 5-5;

FIG. 6 is a schematic cross-sectional view of the actuator shown in FIG. 2, taken along Line 6-6;

FIG. 7 is a schematic cross-sectional view of the actuator shown in FIG. 2, taken along Line 7-7; and

FIG. 8 is a schematic side view of an alternative actuator that may be used in the fluid transfer system shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of self-reciprocating linear hydraulic actuators described below facilitate increased reliability, reduced complexity, and reduced cost of a pump system for oil and gas applications. Specifically, the self-reciprocating linear hydraulic actuator eliminates the need for switching valves. More specifically, the self-reciprocating linear actuator reciprocates without the need for an external valve by utilizing a combination of feed holes, indexing mechanisms, a guided tooth, and channels along the length of the piston. The elimination of valves subsequently reduces the need for the electronic controls required to operate those valves. A reduction in the components required to reciprocate the piston results in an overall reduction in the cost of the pump system in addition to a decrease in the cost of the system due to a reduction in its complexity.

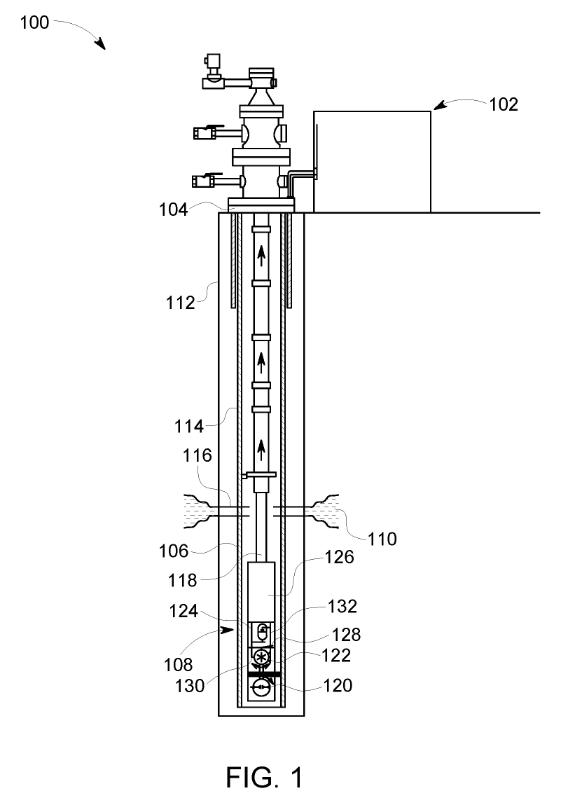

FIG. 1 is a cross-sectional side view of an exemplary resource recovery system 100. Resource recovery system 100 includes a production location 102, a wellhead 104 coupled to a wellbore 106, and a fluid transfer system 108 designed for deployment in wellbore 106. Production location 102 is coupled to and configured to receive production fluids 110, such as, but not limited to petroleum, from wellhead 104. Wellbore 106 is implanted within a landform 112 containing desirable production fluids 110, and lined with a well casing 114. Alternatively, well casing 114 may be positioned in any orientation within landform 112. A plurality of perforations 116 is formed through well casing 114 to permit fluid 110 to flow into wellbore 106 from landform 112. Resource recovery system 100 further includes production tubing 118. Production tubing 118 vertically couples fluid transfer system 108 to wellbore 106. Fluid transfer system 108 includes a motor 120, fluid transfer device 122, accumulator 124, and actuator 126. In the exemplary embodiment, fluid transfer device 122 is a positive displacement pump. Alternatively, pump 122 may be any other fluid transfer device or suitable source of pressure, such as but not limited to a centrifugal pump or a compressor configured to operate in a pneumatic mode. Pump 122 is coupled to and configured to be powered by a motor 120. Motor 120 may be any method suitable for activating pump 122, including but not limited to electric motors. Pump 122 includes a pump inlet 128, and a pump outlet 130. Actuator 126 includes a piston rod 132. Piston rod 132 couples actuator 126 to pump 122. Pump inlet 128 is in fluid communication with actuator 126. Pump outlet 130 is fluid communication with accumulator 124 and actuator 126. In the exemplary embodiment, accumulator 124 is a gas-charged accumulator. Alternatively, accumulator 124 may be a compensator bag configured to act as storage for a volume of hydraulic fluid, such as oil. In the exemplary embodiment, fluid transfer system 108 is configured to pump production fluid 110 from landform 112 toward wellhead 104 through production tubing 118.

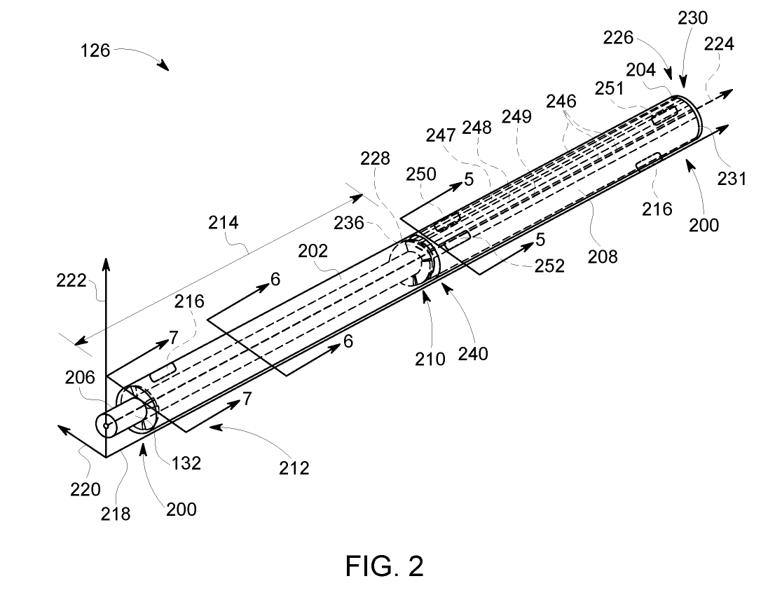

FIG. 2 is a schematic perspective view of actuator 126. In the exemplary embodiment, actuator 126 includes a piston cylinder 200. Piston cylinder 200 has a longitudinal axis 218 and defines a piston chamber 202 including a piston chamber head end 204 and a longitudinally opposite piston chamber base end 206. In the exemplary embodiment, actuator 126 further includes a piston 208 disposed within piston chamber 202, and a piston rod 132 coupled to piston 208. In the exemplary embodiment, piston 208 is movable between a first piston position 210 proximate piston chamber head end 204 and a second piston position 212 proximate piston chamber base end 206, a stroke length 214 of piston 208 defined therebetween. In the exemplary embodiment, actuator 126 further includes deceleration feature 216, a flow bypass hole proximate piston chamber head end 204 and piston chamber base end 206, deceleration FIG. 216 is configured to facilitate deceleration of piston 208 at the end of its stroke length 214. In some alternative embodiments, actuator 126 includes at least one deceleration feature 216 proximate piston chamber head end 204 or piston chamber base end 206.

In the exemplary embodiment, longitudinal axis 218 of piston cylinder 200 extends through piston cylinder 200 in the direction of travel of piston 208. In the exemplary embodiment, a transverse axis 220 extends in a plane substantially parallel to piston chamber base end 206 and normal to longitudinal axis 218. A vertical axis 222 extends in a direction that is normal to longitudinal axis 218 and normal to transverse axis 220. Longitudinal axis 218, transverse axis 220, and vertical axis 222 are orthogonal to each other. A longitudinal centerline 224 extends axially through actuator 126, and is positioned to define the radial center of actuator 126. Longitudinal centerline 224 is substantially parallel to longitudinal axis 218, and common to actuator 126, piston rod 132, piston cylinder 200, piston chamber 202, and piston 208. Thus, longitudinal centerline 224 is positioned to also define the radial center of piston rod 132, piston cylinder 200, piston chamber 202, and piston 208.

In the exemplary embodiment, piston 208 includes a piston head end 226, and a longitudinally opposite piston base end 228. In the exemplary embodiment, piston rod 132 is coupled to piston 208 proximate piston base end 228 and extends axially along longitudinal centerline 224 from proximate piston base end 208 through piston chamber base end 206 to facilitate coupling piston 208 of actuator 126 to pump 122 (shown in FIG. 1).

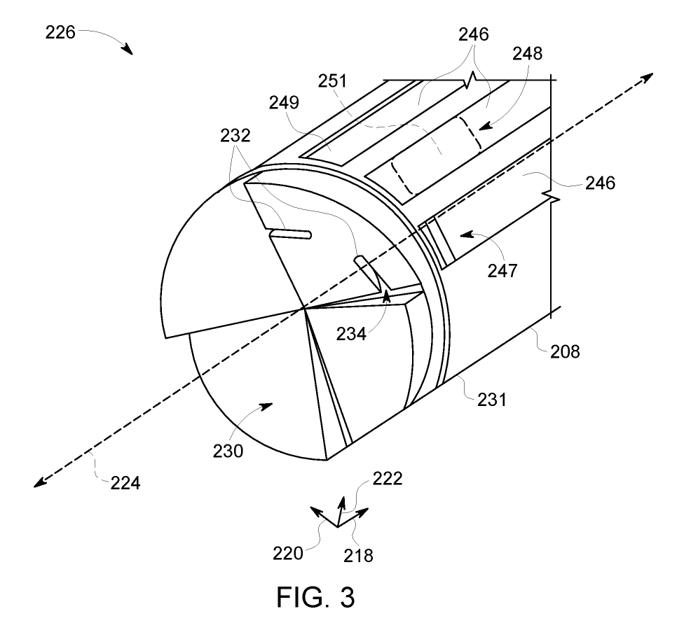

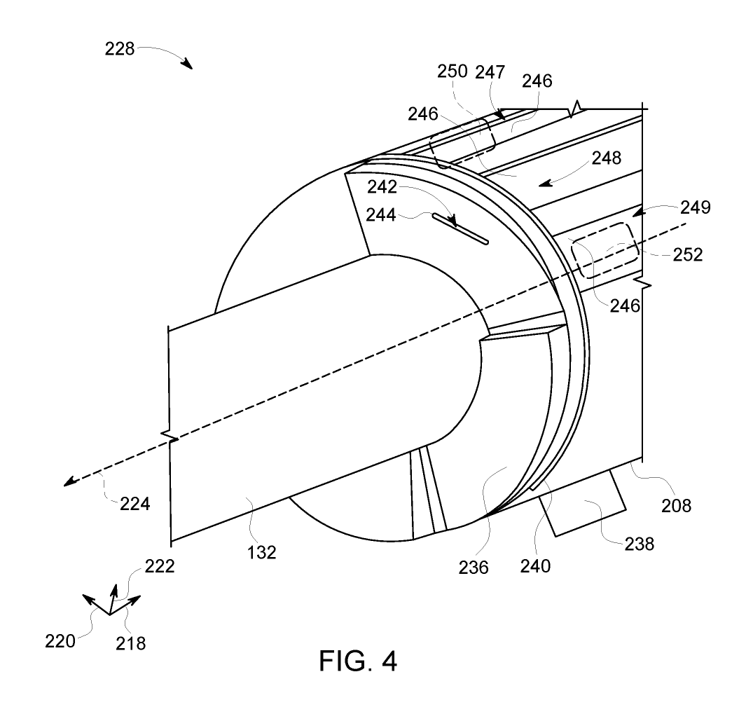

In the exemplary embodiment, piston head end 226 includes a first indexing mechanism 230, a first piston seal 231, and two first feed holes 232 (shown in FIG. 3). In the exemplary embodiment, first feed holes 232 define a flow angle 234 (shown in FIG. 3) configured to induce torque to induce rotation of piston 208. In the exemplary embodiment, piston base end 228 includes a second indexing mechanism 248, a guide tooth 249 (shown in FIG. 4), a second piston seal 240, and a second feed hole 242 (shown in FIG. 4). In the exemplary embodiment second feed hole 242 defines a flow angle 244 (shown in FIG. 4) configured to induce torque to induce rotation of piston 208.

In the exemplary embodiment, piston 208 defines a plurality of channels 246. In the exemplary embodiment, channels 246 include a first channel 247 adjacent to a second channel 248, and a third channel 249, adjacent to second channel 248 extends axially along longitudinal centerline 224 from proximate first piston seal 231 to proximate second piston seal 240. Channels 247, 248, and 249 are spaced radially apart with respect to centerline 224, and are substantially parallel to centerline 224. In the exemplary embodiment, channels 247, 248, and 249, define therein a first opening 250, second opening 251, and third opening 252 respectively. First and third openings 250 and 252 are proximate piston base end 228, and second opening 251 is proximate piston head end 226. In the exemplary embodiment, channels 247, 248, and 249 are in fluid communication with piston chamber 202 through openings 250, 251, and 252 respectively. In some alternative embodiments, openings 250, 251, and 252 may be proximate ends 226, 228, and 226, respectively.

In the exemplary embodiment, Line 5-5 intersects actuator 126 at a point on longitudinal axis 218 defined between first piston position 210 and piston chamber head end 204. Line 6-6 intersects actuator 126 at a point on longitudinal axis 218 defined between first piston position 210 and second piston position 212. Line 7-7 intersects actuator 126 at a point on longitudinal axis 218 defined between second position 212 and piston chamber base end 206.

FIG. 3 is a schematic perspective view of piston head end 226 of piston 208. In the exemplary embodiment, piston head end 226 includes a first indexing mechanism 230, a first piston seal 231, and two first feed holes 232. First indexing mechanism 230 is configured to interact with piston chamber head end 204 (shown in FIG. 2) to facilitate rotating piston 208 within a range between and including approximately 5 degrees and approximately 30 degrees.

In the exemplary embodiment, piston 208 defines a plurality of channels 246. Channels 246 include a first channel 247 adjacent to a second channel 248, and a third channel 249, adjacent to second channel 248. Channels 246, 247, and 248, extend axially along longitudinal centerline 224 from proximate first piston seal 231 to proximate second piston seal 240 (shown in FIGS. 2 and 4). In the exemplary embodiment, second channel 248 defines an opening 251 proximate first piston seal 231.

In the exemplary embodiment, second channel 248 is in fluid communication with piston chamber 202 (shown in FIG. 2) through opening 251. First channel 247 and third channel 249 are in communication with first feed holes 232 and configured to alternate between, facilitating delivery of fluid from within first channel 247 through corresponding first feed hole 232 in the direction of piston chamber head end 204 (shown in FIG. 2), and facilitating delivery of fluid flow into third channel 249 from the direction of piston chamber head end 204 through corresponding first feed hole 232. In the exemplary embodiment, one first feed holes 232 defines a flow angle 234 configured to induce torque to induce rotation of piston 208.

In some alternative embodiments, piston head end 226 may include greater or fewer quantities of first feed holes 232. Additionally, in some embodiments, more than one feed hole 232 may define a flow angle 234. In some alternative embodiments, piston head end 208 may be configured such that, fluid flows into or out of a different channel 247, 248, or 249. Additionally, in some alternative embodiments, indexing mechanism 230 is configured to interact with piston chamber head end 204 (shown in FIG. 2) to facilitate rotating both piston 208 and piston chamber 202 (shown in FIG. 2).

FIG. 4 is a schematic perspective view of piston base end 228 of piston 208. In the exemplary embodiment, piston base end 228 includes a second indexing mechanism 236, a guide tooth 238, a second piston seal 240, and a second feed hole 242. Second indexing mechanism 236 is configured to interact with piston chamber base end 206 (shown in FIG. 2) to facilitate rotating piston 208 within a range between and including approximately 5 degrees and approximately 30 degrees.

In the exemplary embodiment, piston 208 defines a plurality of channels 246. Channels 246 include a first channel 247 adjacent to a second channel 248, and a third channel 249, adjacent to second channel 248. Channels 247, 248, and 249, extend axially along longitudinal centerline 224 from proximate first piston seal 231 (shown in FIGS. 2 and 3) to proximate second piston seal 240. In the exemplary embodiment channels 247, 248, and 249 are spaced radially apart with respect to centerline 224, and are substantially parallel to centerline 224. In the exemplary embodiment, first channel 247 and third channel 249, define openings 250 and 252, respectively, proximate second piston seal 240.

In the exemplary embodiment, first channel 247 and third channel 249 are in fluid communication with piston chamber 202 (shown in FIG. 2) through openings 250 and 252, respectively. Second channel 248 is in communication with second feed hole 242 and is configured to alternate between, facilitating fluid flow from within channel 248 in the direction of piston chamber base end 206 through feed hole 242, and facilitating fluid flow from the direction of piston chamber base end 206 (shown in FIG. 2) through feed hole 242 into second channel 248. In the exemplary embodiment, second feed hole 242 defines a flow angle 244 configured to induce torque to induce rotation of piston 208.

In some alternative embodiments, piston base end 210 may include greater or fewer quantities of second feed holes 242. Additionally, in some embodiments, more than one feed hole 242 may define a flow angle 244. In some alternative embodiments, piston base end 210 may be configured such that, fluid flows into or out of a different channel 247, 248, or 249. Additionally, in some alternative embodiments, indexing mechanism 236 is configured to interact with piston chamber base end 206 (shown in FIG. 2) to facilitate rotating both piston 208 and piston chamber 202.

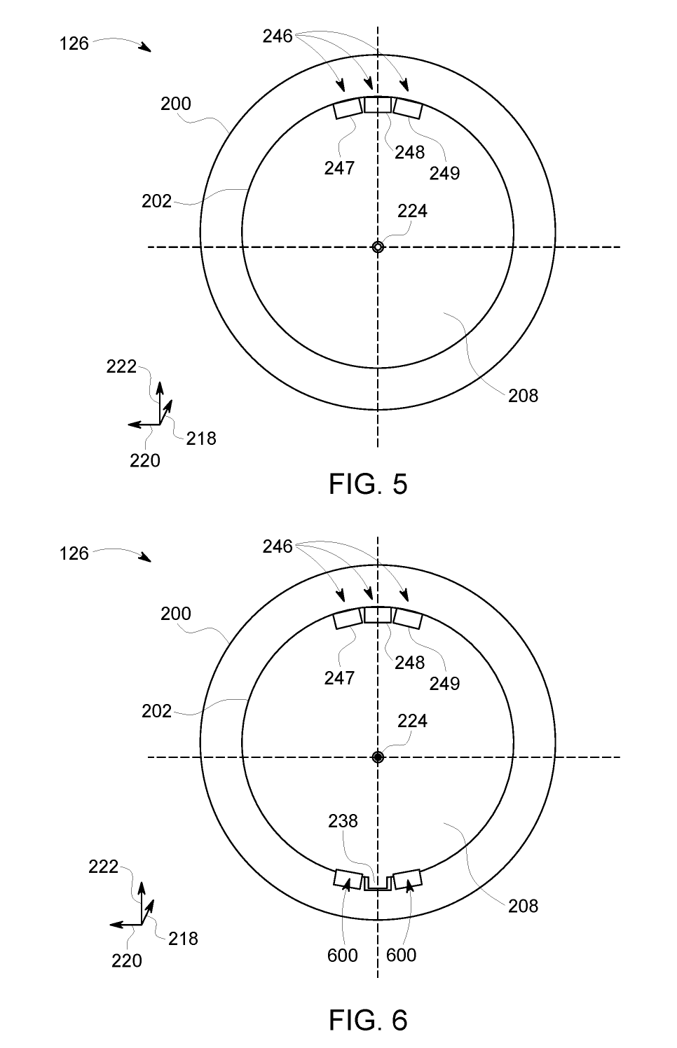

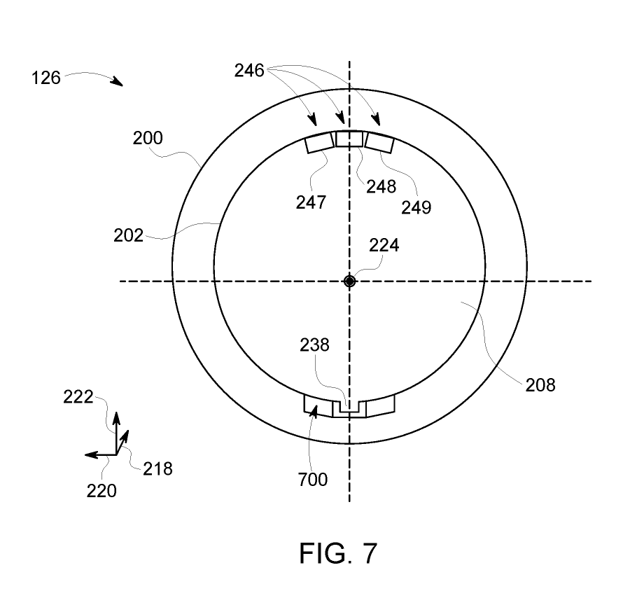

FIG. 5 is a schematic cross-sectional view of actuator 126 taken along Line 5-5, FIG. 6 is a schematic cross-sectional view of actuator 126 taken along Line 6-6, and FIG. 7 is a schematic cross-sectional view of actuator 126 taken along Line 7-7.

Referring to FIGS. 5-7, in the exemplary embodiment, actuator 126 includes a piston cylinder 200 defining a piston chamber 202, a piston 208 disposed within piston chamber 202, and a longitudinal centerline 224 (although shown in FIGS. 5-7 as a point, longitudinal centerline is a line extending axially through actuator 126). Longitudinal centerline 224 is positioned to define the radial center of actuator 126 and is substantially parallel to longitudinal axis 218.

In the exemplary embodiment, Piston 208 includes a guide tooth 238 and defines a plurality of channels 246. Channels 246 include channels 247, 248, and 249, extending axially along longitudinal centerline 224 from proximate first piston seal 231 (shown in FIGS. 2 and 3) to proximate second piston seal 240 (shown in FIGS. 2 and 4). In the exemplary embodiment channels 247, 248, and 249 are spaced radially apart with respect to centerline 224, and are substantially parallel to centerline 224.

In the exemplary embodiment, piston chamber 202 defines a plurality of guide slots 600. Guide slots 600 extend both radially outward from proximate piston 208 into piston chamber 202, and longitudinally from proximate first piston position 210 (shown in FIG. 2) to proximate second piston position 212 (shown in FIG. 2) Guide slots 600 are configured to merge into one or more free slots 700 at the end of each stroke length 214. Guide tooth 249 is configured to ride within at least one guide slot 600 to substantially inhibit rotation of piston 208 prior to the end of the stroke length 214. In alternative embodiments, Piston chamber 202 may define a different quantity of guide slots 600.

In operation, motor 120 is coupled to and activates pump 122. Pump 122 is coupled to actuator 126 by piston rod 132. Pump inlet 128 is in fluid communication with actuator 126, and pump outlet 130 is fluid communication with accumulator 124 and actuator 126. In operation, oil flows from pump outlet 130 and mixes with oil from accumulator 124 before flowing into actuator 126.

In operation, piston cylinder 200 becomes pressurized by a mixture of oil from pump outlet 130 and accumulator 124. Initially, piston 208 is in second piston position 212, such that piston base end 228 is proximate piston chamber base end 206. Second channel 248 is initially aligned with pump outlet 130, and third channel 248 is initially aligned with pump outlet 130, such that, oil flows into flows into opening 251 of second channel 248, proximate piston head end 226.

Also, in operation, as oil enters second channel 248 it flows toward piston base end 228. As oil reaches piston base end 228, it flows through second feed hole 242 at a flow angle 244, into piston chamber base end 206. The flow of oil into piston chamber base end 206 facilitates moving piston 208 in the direction of piston chamber head end 204, while filling piston chamber base end 206 with oil. As piston 208 moves toward head end 204, guide tooth 249 rides within a guide slot 600 to substantially inhibit piston 208 from rotating due to the inertia induced by oil flowing from second feed hole 242 at flow angle 244. Additionally, in operation, piston seals 231 and 240, facilitate a reduction in oil flowing past piston ends 226 and 228, into piston chamber ends 204 and 206, respectively

Also, in operation, once piston 208 has reached the end of its stroke length 214, guide slots 600 merge into a free slot 700, and first indexing mechanism 230 adjacent piston head end 208 interacts with piston chamber head end 204. The interaction of first indexing mechanism 230 in combination with the torque induced by flow angle 244, and the increased range of movement provided by free slot 700 facilitates rotating piston 208 within a range between and including approximately 5 degrees and approximately 30 degrees. As piston 208 rotates, second channel 248 becomes aligned with pump inlet 128, and first channel 247 becomes aligned with pump outlet 130.

Simultaneously, in operation, piston chamber base end 206 has become the low pressure side of piston chamber 202 and oil begins to flow from out of second channel 248, through second feed hole 242, into pump inlet 128. Simultaneously, in operation, oil from pump outlet 130 flows into opening 250 of first channel 247. Oil then flows through first channel 247 toward piston head end 208. Oil then flows from first channel 247 through first feed hole 232 into piston chamber head end 204 at flow angle 234.

Additionally, in operation, the flow of oil out of piston chamber base end 206 in combination with the flow of oil into piston chamber head end 204 facilitates moving piston 208 in the direction of piston chamber base end 206, while filling piston chamber head end 204 with oil. As piston 208 moves toward piston chamber base end 206 guide tooth 249 rides within a guide slot 600 to substantially inhibit piston 208 from rotating due to the torque induced by oil flowing from first feed hole 247 at flow angle 234. Also, in operation, once piston 208 has reached the end of its stroke length 214, guide slots 600 merge into a free slot 700, and second indexing mechanism 236 interacts with piston chamber base end 206.

In operation, the interaction of indexing mechanism 236 and piston chamber base end 206, in combination with the torque induced by flow angle 234, and the increased range of movement provided by free slot 700 facilitates rotating piston 208 within a range between and including approximately 5 degrees and approximately 30 degrees. As piston 208 rotates, second channel 248 becomes realigned with pump outlet 130, and third channel 249 becomes aligned with pump inlet 128.

Also in operation, subsequently, piston chamber head end 204 has become the low pressure side of piston chamber 202 and oil begins to flow from out of piston chamber head end 204, into third channel 249 through a corresponding feedhole 232. Oil then flows from opening 252 of third channel 249 into pump inlet 128. As this occurs, oil flows into opening 251 of second channel 248 and flows through second channel 248 toward piston base end 228. Oil then flows through second feed hole 242 into piston chamber base end 206.

Additionally, in operation, the flow of oil out of piston chamber head end 204 in combination with the flow of oil into piston chamber base end 206 facilitates moving piston 208 in the direction of piston chamber head end 204, while filling piston chamber base end 206 with oil. The continuous exchange of oil between piston chamber head end 204 and piston chamber base end 206, results in a reciprocating motion of piston 208. In operation, piston rod 132 is coupled to both pump 122 and piston 208, and facilitates driving pump 122 through the reciprocating motion of piston 208. Once pump 122 is activated, and piston 208 begins to reciprocate, the continuous movement of piston 208 in combination with the flow of oil between pump 122 and actuator 126 allows actuator 126 to reciprocate and drive pump 122 without the need for external valves.

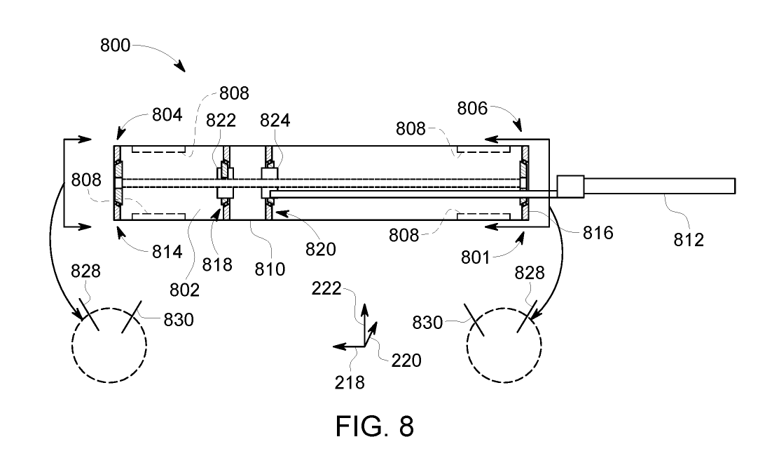

FIG. 8 is a schematic side view of an alternative actuator 800 that may be used in fluid transfer system 108 (shown in FIG. 1). In an alternative embodiment, actuator 800 includes a piston cylinder 801. Piston cylinder 801 defines a piston chamber 802, having a piston chamber head end 804 and a piston chamber base end 806. Actuator 800 further includes a plurality of deceleration features 808, a piston 810, and piston rod 812. Piston chamber head 804 includes an indexing mechanism 814 and piston chamber base end 806 includes an indexing mechanism 816. Piston 810 has a head end 818, and a base end 820. Piston head end 818 includes an indexing mechanism 822, and piston base end 820 includes an indexing mechanism 824. Additionally, in this alternative embodiment, a pump 826 (not shown) includes a pump inlet 828, and an accumulator 827 (not shown) includes an outlet 830. Pump inlet 828 is in fluid communication with actuator 800 proximate both piston chamber head and base ends 804 and 806. Accumulator outlet 830 is in fluid communication with actuator 800 proximate both head and base ends 804 and 806.

In a method of operation similar to the description above, as piston 810 moves toward a position proximate piston chamber ends 804 and 806, deceleration features 808 interrupt oil flow, facilitating a deceleration of piston 810. As piston 810 moves toward a position proximate piston chamber head end 804, indexing mechanism 814 on piston chamber head end 804 interacts with indexing mechanism 822 on piston head end 818 to facilitate simultaneously rotating both piston chamber 802 and piston 810 a range between and including approximately 5 degrees and approximately 30 degrees relative to each other. The simultaneous motion of piston chamber 802 and piston 810 concurrently closes pump inlet 828 and opens accumulator outlet 830 proximate piston chamber head end 804, while concurrently opening pump inlet 828 and closing accumulator outlet 830 proximate piston chamber base end 806. This causes oil to flow into piston chamber head end 804 and out of piston chamber base end 806.

Additionally, in operation, the flow of oil into piston chamber head end 804 in combination with the flow of oil out of piston chamber base end 806 facilitates moving piston 810 in the direction of piston chamber base end 806. As piston 810 moves toward a position proximate piston chamber base end 806, indexing mechanism 816 on piston chamber base end 806 interacts with indexing mechanism 824 on piston base end 820 to facilitate simultaneously rotating both piston chamber 802 and piston 810 a range between and including approximately 5 degrees and approximately 30 degrees relative to each other. The simultaneous motion of piston chamber 802 and piston 810 concurrently opens pump inlet 828 and closes accumulator outlet 830 proximate piston chamber head end 804, while concurrently closing pump inlet 828 and opening accumulator outlet 830 proximate piston chamber base end 806. This causes oil to flow out of piston chamber head end 804 and into piston chamber base end 806. The flow of oil out of piston chamber head end 804 in combination with the flow of oil into piston chamber base end 806 facilitates moving piston 810 in the opposite direction.

Embodiments of a self-reciprocating linear hydraulic actuator as described herein facilitate increased reliability, reduced complexity, and reduced cost of a pump system for oil and gas applications. Specifically, the self-reciprocating linear hydraulic actuator eliminates the need for switching valves. More specifically, the self-reciprocating linear actuator reciprocates without the need for an external valve by utilizing a combination of feed holes, indexing mechanisms, a guided tooth, and channels along the length of the piston. The elimination of valves subsequently reduces the need for the electronic controls required to run those valves. A reduction in the components required to reciprocate the piston results in an overall reduction in the cost of the pump system in addition to a decrease in the cost of the system due to a reduction in its complexity. Additionally, reductions in the use of electronic controls and the complexity of the valve schemes result in a substantially mechanical linear pump.

An exemplary technical effect of the methods and systems described herein includes at least one of: (a) eliminating the need for valves; (b) eliminating the need for electronic controls for switching valves; (c) reducing cost requirements; (d) reducing space requirements; (e) facilitating pump operation at a constant flow rate; (f) improving the reliability of the pump system; and (g) reducing complexity of the pump system.

Exemplary embodiments of methods, systems, and apparatus for a self-reciprocating hydraulic linear actuator are described above in detail. The apparatus, systems, and methods are not limited to the specific embodiments described herein, but rather, operations of the methods and components of the systems may be utilized independently and separately from other operations or components described herein. For example, the systems, methods, and apparatus described herein may have other industrial or consumer applications and are not limited to practice with components as described herein. Rather, one or more embodiments may be implemented and utilized in connection with other industries.

Although specific features of various embodiments of the technology may be shown in some drawings and not in others, this is for convenience only. In accordance with the principles of the invention, any feature of a drawing may be referenced or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An actuator for use with a fluid transfer device, said actuator comprising:
a piston cylinder having a longitudinal axis and defining a piston chamber including a piston chamber head end and a piston chamber base end longitudinally opposite said piston chamber head end; and
a piston disposed within said piston chamber, said piston movable between a first piston position proximate said piston chamber head end and a second piston position proximate said piston chamber base end, said piston comprising:
a piston head end comprising a first indexing mechanism and a first piston seal, said piston head end defining at least one first feed hole therein; and
a piston base end longitudinally opposite said piston head end, said piston base end comprising a second indexing mechanism, a guide tooth, and a second piston seal, said piston base end defining at least one second feed hole therein, wherein said piston defines a plurality of channels therein, said plurality of channels extend from proximate said first piston seal to proximate said second piston seal.

2. The actuator in accordance with claim 1, wherein said piston chamber is in fluid communication with a fluid transfer device and said plurality of channels.

3. The actuator in accordance with claim 1, wherein said first piston position and said second position define a stroke length of said piston.

4. The actuator in accordance with claim 3 further comprising at least one deceleration feature proximate at least one of said piston chamber head end and said piston chamber base end, wherein said deceleration feature is a flow bypass hole configured to decelerate said piston at the end of the stroke length.

5. The actuator in accordance with claim 1, wherein at least one of said first feed holes and said second feed holes defines a flow angle configured to induce torque to induce rotation of at least one of said piston and said piston chamber.

6. The actuator in accordance with claim 1, wherein at least one of said first indexing mechanism and said second indexing mechanism is configured to rotate at least one of said piston and said piston chamber within a range between and including approximately 5 degrees and approximately 30 degrees.

7. The actuator in accordance with claim 1, wherein each channel of said plurality of channels defines an opening therein, said opening proximate one of said first piston seal and said second piston seal, and said plurality of channels are in communication with at least one of said first feed holes and at least one of said second feed holes, said plurality of channels configured to facilitate fluid flow through said first feed holes and said second feed hole in a direction of at least one of said piston chamber head end and said piston chamber base end.

8. The actuator in accordance with claim 1, wherein said piston chamber defines a plurality of guide slots therein, said plurality of guide slots extend from proximate said piston chamber base end to a distance defined by the stroke length of said piston, said plurality of guide slots configured to merge into one or more free slots at the end of each stroke length, said guide tooth configured to ride within at least one of said plurality of guide slots to substantially inhibit rotation of said piston prior to the end of the stroke length.

9. A fluid transfer system comprising:
a motor;
a fluid transfer device coupled to said motor; and
an actuator comprising:
a piston cylinder having a longitudinal axis and defining a piston chamber including a piston chamber head end and a piston chamber base end longitudinally opposite said piston chamber head end; and
a piston disposed within said piston chamber, said piston movable between a first piston position proximate said piston chamber head end and a second piston position proximate said piston chamber base end, said piston comprising:
a piston head end comprising a first indexing mechanism and a first piston seal, said piston head end defining at least one first feed hole therein; and
a piston base end longitudinally opposite said piston head end, said piston base end comprising a second indexing mechanism, a guide tooth, and a second piston seal, said piston base end defining at least one second feed hole therein, wherein said piston defines a plurality of channels therein, said plurality of channels extend from proximate said first piston seal to proximate said second piston seal.

10. The fluid transfer system in accordance with claim 9, further comprising:
a piston rod coupled to said piston, wherein said first piston position and said second piston position define a stroke length of said piston, said piston rod configured to couple said actuator to said fluid transfer device, wherein said fluid transfer device is a positive displacement pump comprising a pump inlet and a pump outlet; and
an accumulator in fluid communication with said pump.

11. The fluid transfer system in accordance with claim 9, further comprising at least one deceleration feature proximate at least one of said piston chamber head end and said piston chamber base end, wherein said deceleration feature is a flow bypass hole configured to decelerate said piston at the end of the stroke length.

12. The fluid transfer system in accordance with claim 9, wherein at least one of said first feed holes and said second feed holes defines a flow angle configured to induce torque to induce rotation of at least one of said piston and said piston chamber.

13. The fluid transfer system in accordance with claim 9, wherein at least one of said first indexing mechanism and said second indexing mechanism is configured to rotate at least one of said piston and said piston chamber within a range between and including approximately 5 degrees and approximately 30 degrees.

14. The fluid transfer system in accordance with claim 9, wherein each channel of said plurality of channels defines an opening therein, said opening proximate one of said first piston seal and said second piston seal, and said plurality of channels are in communication with at least one of said first feed holes and at least one of said second feed holes, said plurality of channels configured to facilitate fluid flow through said first feed holes and said second feed hole in a direction of at least one of said piston chamber head end and said piston chamber base end.

15. The fluid transfer system in accordance with claim 9, wherein said piston chamber defines a plurality of guide slots therein, said plurality of guide slots extend from proximate said piston chamber base end to a distance defined by the stroke length of said piston, said plurality of guide slots configured to merge into one or more free slots at the end of each stroke length, said guide tooth configured to ride within at least one of said plurality of guide slots to substantially inhibit rotation of said piston prior to the end of the stroke length.

16. A resource recovery system comprising:
a wellhead;
a production location coupled to said wellhead and configured to receive resources from said wellhead; and
a fluid transfer system comprising
a motor;
a fluid transfer device coupled to said motor; and
an actuator comprising:
a piston cylinder having a longitudinal axis and defining a piston chamber including a piston chamber head end and a piston chamber base end longitudinally opposite said piston chamber head end; and
a piston disposed within said piston chamber, said piston movable between a first piston position proximate said piston chamber head end and a second piston position proximate said piston chamber base end, said piston comprising:
a piston head end comprising a first indexing mechanism and a first piston seal, said piston head end defining at least one first feed hole therein; and
a piston base end longitudinally opposite said piston head end, said piston base end comprising a second indexing mechanism, a guide tooth, and a second piston seal, said piston base end defining at least one second feed hole therein, wherein said piston defines a plurality of channels therein, said plurality of channels extend from proximate said first piston seal to proximate said second piston seal.

17. The resource recovery system in accordance with claim 16, further comprising:
a piston rod coupled to said piston, wherein said first piston position and said second piston position define a stroke length of said piston, said piston rod configured to couple said actuator to said fluid transfer device, wherein said fluid transfer device is a positive displacement pump comprising a pump inlet and a pump outlet;
an accumulator in fluid communication with said pump; and
at least one deceleration feature proximate at least one of said piston chamber head end and said piston chamber base end, wherein said deceleration feature is a flow bypass hole configured to decelerate said piston at the end of the stroke length.

18. The resource recovery system in accordance with claim 16, wherein at least one of said first indexing mechanism and said second indexing mechanism are configured to rotate at least one of said piston and said piston chamber within a range between and including approximately 5 degrees and approximately 30 degrees.

19. The resource recovery system in accordance with claim 16, wherein each channel of said plurality of channels defines an opening therein, said opening proximate one of said first piston seal and said second piston seal, and said plurality of channels are in communication with at least one of said first feed holes and at least one of said second feed holes, said plurality of channels configured to facilitate fluid flow through said first feed holes and said second feed hole in the direction of at least one of said piston chamber head end and said piston chamber base end, wherein at least one of said first feed holes and said second feed holes defines a flow angle configured to induce torque to induce rotation of at least one of said piston and said piston chamber.

20. The resource recovery system in accordance with claim 17, wherein said piston chamber defines a plurality of guide slots therein, said plurality of guide slots extend from proximate said piston chamber base end to a distance defined by the stroke length of said piston, said plurality of guide slots configured to merge into one or more free slots at the end of each stroke length, said guide tooth configured to ride within at least one of said plurality of guide slots to substantially inhibit rotation of said piston prior to the end of the stroke length.
